(19) United States
(12) Patent Application Publication
(10) Pub. No.: US 2016/0184898 A1
(43) Pub. Date: Jun. 30, 2016

(54) MANUFACTURING PRODUCTS COMPRISING A THREE-DIMENSIONAL PATTERN OF CELLS

(71) Applicant: Nir Kohav, San Francisco, CA (US)

(72) Inventor: Nir Kohav, San Francisco, CA (US)

(21) Appl. No.: 14/981,494

(22) Filed: Dec. 28, 2015

Related U.S. Application Data
(60) Provisional application No. 62/098,289, filed on Dec. 30, 2014.

(51) Int. Cl. B22F 5/00; B28B 1/00; B29C 67/00

(52) U.S. Cl. CPC B22F 5/00; B29C 67/0051; B28B 1/001; A23P 1/00; B33Y 10/00

(57) ABSTRACT

Various manufacturing processes, such as three-dimensional (3D) printing, are used to create products having internal structures with a repeating three-dimensional pattern. A three-dimensional pattern in an internal structure includes multiple cells, with each cell formed from material occupying less than 100% of the volume of the cell. While material in a cell does not completely fill the cell, material in each cell of the repeating pattern connects to material in one or more neighboring cells of the three-dimensional pattern.

### CROSS REFERENCE TO RELATED APPLICATIONS

This application claims the benefit of U.S. Provisional Application No. 62/098,289, filed Dec. 30, 2014, which is incorporated by reference in its entirety.

### BACKGROUND

Current methods of forming products include injection molding, casting, machining, extruding, welding, and brazing. However, most conventional methods of forming products are ill-suited for forming products having complex internal and external structures. For example, molding and casting creates solid products, while extrusion results in product shapes with limited selection of profile sections. Additionally, tools used in machining processes have inherent limitations on fabrication limitation such as limits from rotational motion of a shaping bit used to manufacture products. Products formed by combining structures through welding, brazing, or gluing also have various logistical limitations preventing creation of complex internal structures. Products formed by combining structures also have relative large density and bulk because of conventional fabrication methods. Accordingly, conventional manufacturing methods are unable to create products including one or more complex three-dimensional repeating patterns.

### SUMMARY

Three-dimensional (3D) printing allows manufacturers to more easily make complex three-dimensional structures. In various embodiments, 3D printing methods allow creation of products having internal structures with a repeating three-dimensional pattern. A three-dimensional pattern includes multiple cells, with each cell having material occupying less than 100% of the volume of the cell. While material in a cell does not completely fill the cell, material in each cell of the repeating pattern connects to material in one or more neighboring cells of the three-dimensional pattern, providing structural stability for the structure formed by the plurality of cells in the repeating pattern. In various embodiments, a layout identifying positions of cells relative to each other and properties of cells in different locations is used to create a structure comprising cells of a selected material having positions relative to each other and properties specified by the layout. Using a repeating three-dimensional pattern as a structure of a product also provides structural support for forming complex outer shells of external structures of a product, such as complex curves. Hence, a product is created by selecting a material, generating a layout identifying multiple cells, and generating the product as a pattern of cells created from the selected material according to the layout.

Products comprising three-dimensional structures have higher strength-to-weight ratios than products with solid internal structures. Additionally, three-dimensional internal structures may be configured to allow for fluid flow through cells comprising the three-dimensional structures in one or more axes or directions. Any suitable material capable of being printed using 3D printing methods may be used to form cells of three-dimensional internal structures. Various properties of a three-dimensional internal structure may be modified for different implementations. For example, the comprising included in a three-dimensional structure is modified to provide different structural rigidity, insulation, acoustical insulation, fluid flow, or any other property in different embodiments. Other properties of a three-dimensional structure that may be modified include dimensions of the three-dimensional structure and material comprising the three-dimensional structure. Altering properties of the three-dimensional structure may modify one or more of: structural rigidity or strength along various axes, structure weight, thermal conductivity, thermal insulation, acoustical insulation, filtration, elastic response, pressure relief, or other suitable properties (for gases or liquids, with open cells), building block, space divider, texture, or any other suitable property.

Several applications of different structures achievable in embodiments of the invention are described. Additionally, other manufacturing techniques may be used to produce the three-dimensional structures further described herein, so embodiments of the invention include the three-dimensional structures themselves, regardless of the techniques used to create the three-dimensional structures.

### BRIEF DESCRIPTION OF THE DRAWINGS

FIG. 1 is an example of creating a structure from a pattern of cells of material, in accordance with an embodiment.

FIG. 2 is an example of layouts of cells for creating a structure, in accordance with an embodiment.

FIG. 3 shows example designs of walls of a cell, in accordance with an embodiment.

FIG. 4 shows examples of ribs included in a cell, in accordance with an embodiment.

FIG. 5 shows examples of different surfaces of walls of a cell, in accordance with an embodiment.

FIG. 6 shows an example of a cylinder block formed from cells, in accordance with an embodiment.

FIG. 7 shows an example structure for cooling comprising cells, in accordance with an embodiment.

FIG. 8 shows examples of additional structures comprising multiple cells for cooling fluids, in accordance with an embodiment

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Patterns and Geometric Variations

Various manufacturing processes, such as three-dimensional (3D) printing, are used to create products having internal structures with a repeating three-dimensional pattern. A three-dimensional pattern in an internal structure includes multiple cells, with each cell formed from material occupying less than 100% of the volume of the cell. While material in a cell does not completely fill the cell, material in each cell of the repeating pattern connects to material in one or more neighboring cells of the three-dimensional pattern.

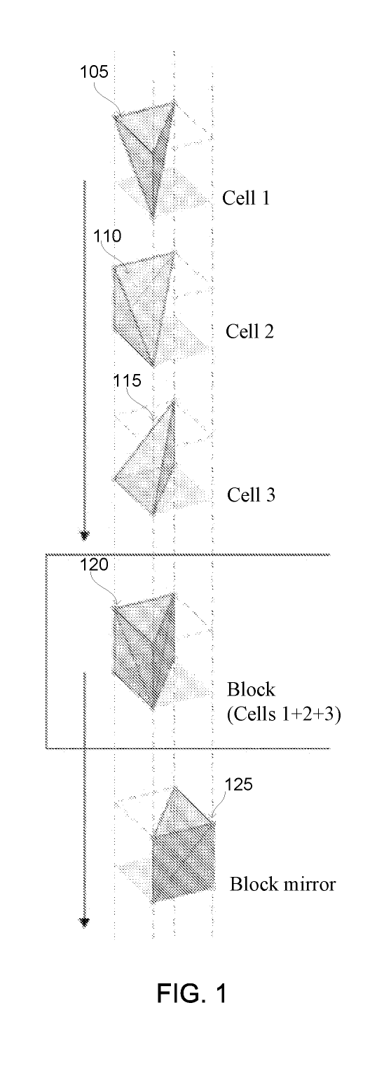

Internal structures may have different patterns in different embodiments. In some embodiments, a pattern includes multiple identical cells. Alternatively, a pattern includes different cells at different locations, so different locations in a structure formed using the pattern have different properties. FIG. 1 illustrates an example of creating a structure 125 as a pattern of cells. In the example of FIG. 1, the structure 120 comprises a pattern of multiple cells 105, 110, 115 of a material arranged so material in a cell is connected to material in at least one other cell. Each cell in the pattern comprising the structure 120 includes material filling less than 100% of the cell, but each cell includes material coupled to material included in at least one adjacent cell. For example, cell 105 includes material coupled to material included in cell 110, and cell 110 includes material coupled to material included in cell 115 in the example of FIG. 1. Reorienting the cells 105, 110, 115 allows creation of an additional structure 125, shown in FIG. 1; hence using different layouts specifying different positions of cells 105, 110, 115 relative to each other or specifying different properties of cells 105, 110, 115, allows different structures 120, 125 to be created from cells 105, 110, 115.

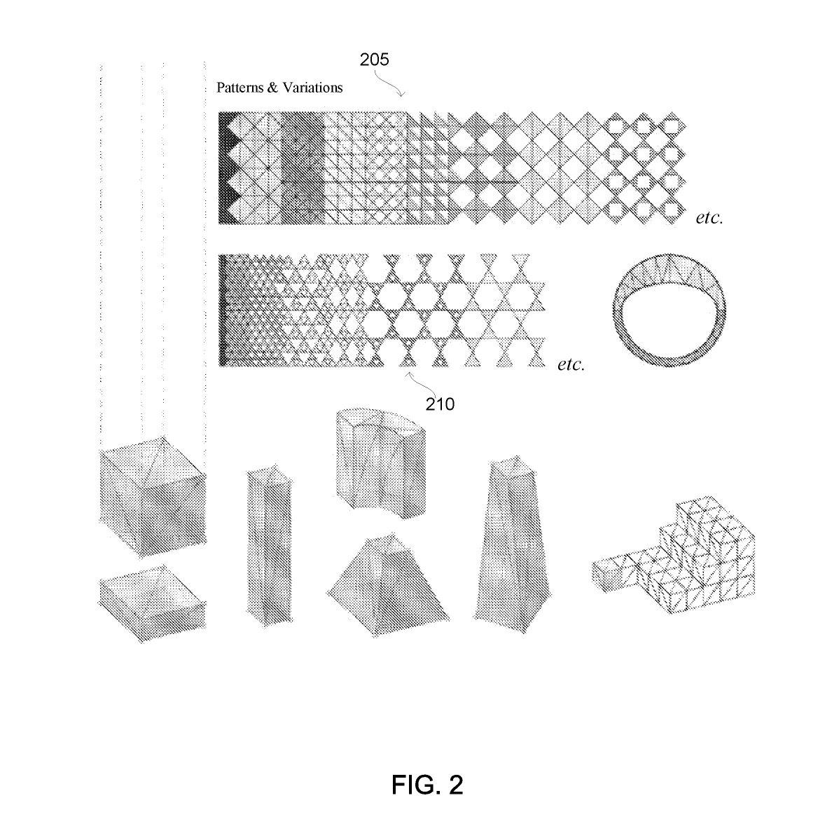

FIG. 2 shows different layouts 205, 210 specifying different positions of cells relative to each other, allowing creation of different structures having cells in the positions relative to each other specified by a layout 205, 210. For example, a layout 205, 210 specifies positions of cells to form a cube, and a generated structure comprises cells formed from a material and having positions relative to each other based on the layout 205, 210. Multiple cubes may be created from the pattern and arranged in a three-dimensional grid. In other embodiments, the cells may be distorted while also arranged in a repeating pattern by modifying properties of cells in different positions in the layout. For example, aspect ratios of one or more cells may be modified by stretching or compressing the cells along one or more axes. Alternatively, cells may be distorted in a curved pattern, such as to create a semicircle in one axis, allowing cells to subsequently be arranged in a cylindrical pattern. Other geometries in which cells may be arranged to form internal structures are illustrated in FIG. 2.

Moreover, a layout 205, 210 may identify different amounts of material in different cells, so a structure formed based on the layout includes cells in different positions that include different amounts or configurations of materials. For example, cells within a threshold distance of an exterior surface of a structure formed by a pattern of cells have more material included in them, while cells greater than the threshold distance from the exterior surface of the structure include less material. Specifying different properties of cells based on positions of cells relative to each other allows creation of structures providing different functionality. For example, a pattern including cells having different characteristics modifies fluid flow within a structure formed by arranging the cells, modifies insulation characteristics of different regions of the structure, or varies strength-to-weight ratios of different regions of the structure.

Various properties of the cells may be modified for use in different implementations. For example, cells may be generated from different materials for different applications of structures created from the cells. In some embodiments, the cells are made from metal to provide electrical conductivity, thermal conductivity, structural strength, and higher melting points. Alternatively, cells may be created from plastic to create lightweight, non-conductive, corrosion-resistant structures from an inexpensive material. Elastic materials (e.g., silicone, rubber) may be used to create cells in some embodiments to create a flexible or elastic structure from a pattern of the cells. Living materials may be used to form cells in some embodiments, and edible materials (e.g., batter) may be used to create cells in other embodiments.

Additionally, each cell has one or more walls, which may have different characteristics in different embodiments. For example, thickness of cell walls may differ in various embodiments. Thicker cell walls provide greater strength for the cell, and increase resiliency if walls are formed from elastic materials. Thinner walls reduce weight in various embodiments.

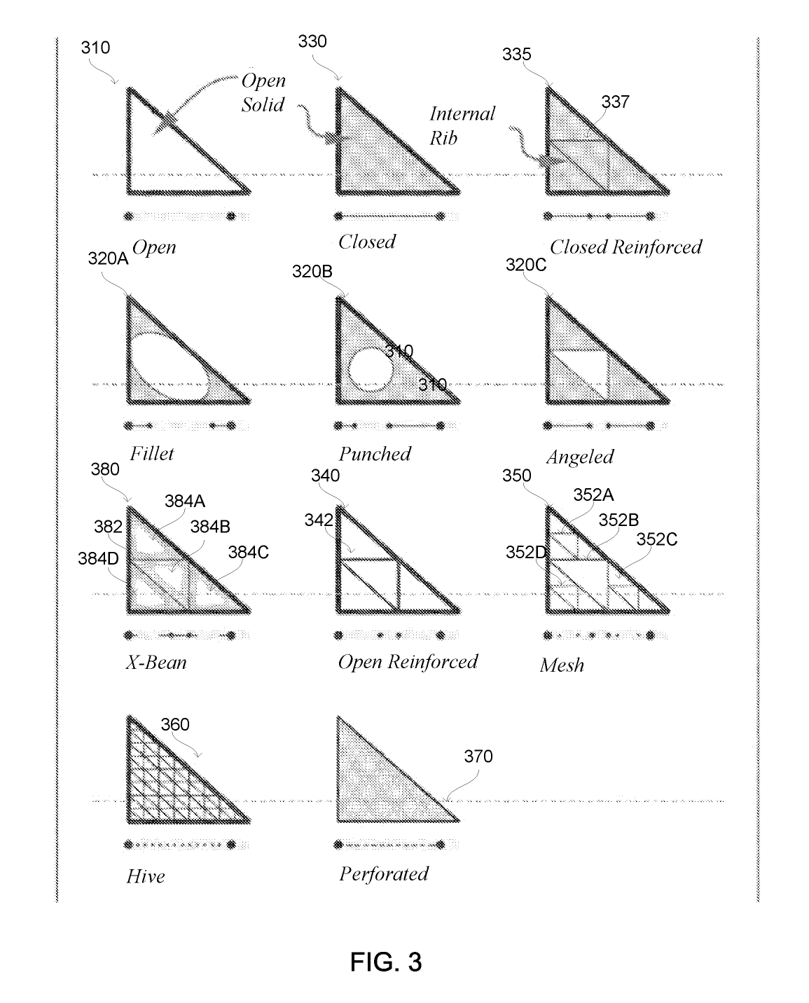

FIG. 3 shows example designs of a wall of a cell. For example, wall 310 has greater than a threshold opening, which lightens a resulting structure and provides less resistance to fluid flow through the cell. Walls 320A-320C have less than a threshold opening, which strengthens a resulting structure while increasing the structure's weight. Additionally, walls 320A-320A having less than the threshold opening provide increased resistance to fluid flow through a cell and allow for filtering of smaller particulates from fluid or flowing through the cell. Different types of openings may be included in different types of walls. Wall 320A has a fillet opening, and wall 320B has a punched opening, while wall 320C has an angled opening. Wall 330 is closed, which provides a stronger, yet heavier, structure preventing fluid flow through a cell and providing increased thermal or acoustic insulation. In some embodiments, a closed wall also includes an internal rib to reinforce the wall. In FIG. 3, wall 335 includes an internal rib 337. In some embodiments, a closed wall includes an internal rib as well as one or more openings; wall 380 in FIG. 3 is a closed wall including an internal rib 382 and also having multiple openings 384A-384D. Similarly, an open wall may include one or more internal ribs. In FIG. 3, wall 340 is an open wall with an internal rib 342, while wall 350 is open and includes multiple internal ribs 352A-352D; similarly wall 360 is open and includes multiple internal ribs. Additionally a closed wall may include multiple perforations, as illustrated by wall 370 in FIG. 3

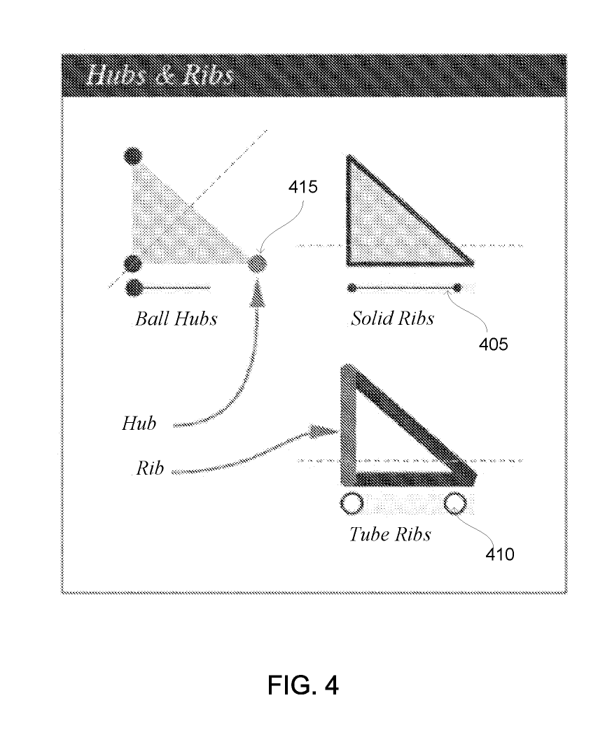

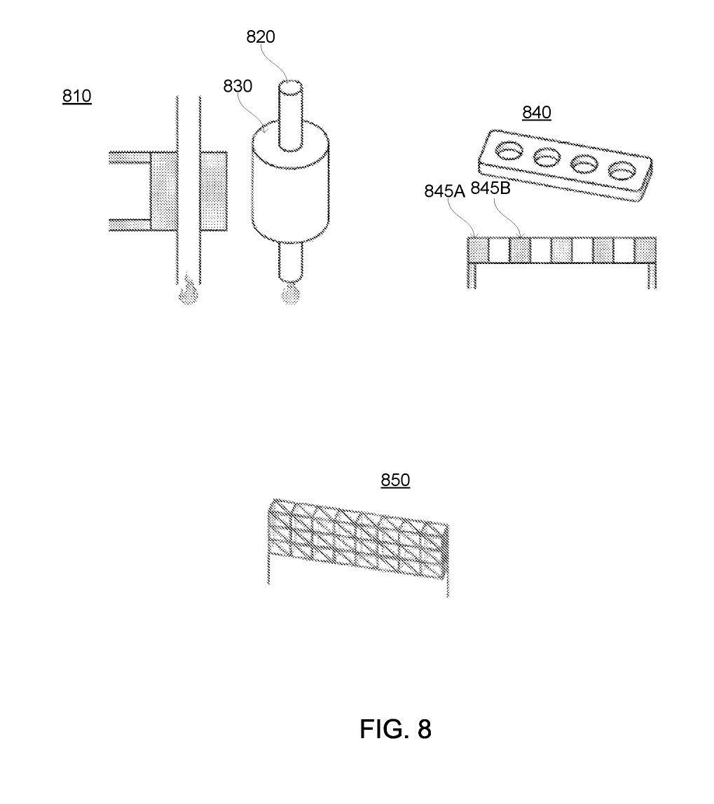

Cells may include different types of ribs in different embodiments. Various gases or liquids may be directed through types of ribs in various embodiments, as further described below (e.g., in conjunction with FIG. 8). FIG. 4 shows example types of ribs included in cells. For example, solid ribs 405 may be included in cells. Alternatively tube ribs 410 may be included in cells. However, ribs in cells may have any suitable cross-sections (e.g., a “T” cross section, an “I” cross section). In some embodiments, corners of ribs in cells are rounded to improve strength-to-weight ratios of structures formed from the cells. Alternatively, ribs in various cells have 45-degree corners or corners with other suitable angles. Hubs 415 may be used to couple ribs together in some embodiments, with any suitable type of hub 415 used in different embodiments. Alternatively, cells that do not include ribs may be generated in some embodiments.

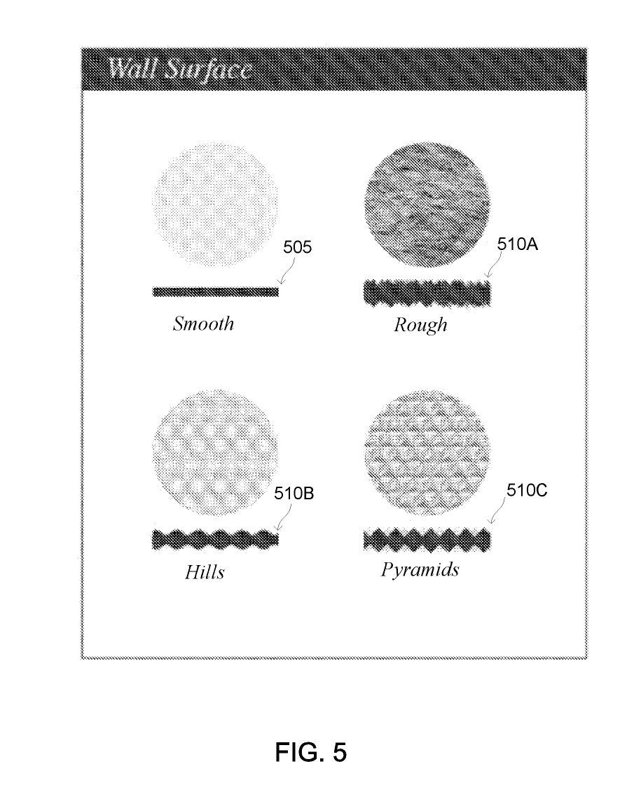

As shown in FIG. 5, cell walls may have different surfaces in different embodiments. FIG. 5 shows a wall 505 with a smooth surface, which may be quicker to produce and less likely to have other material remain affixed to the wall 505. Additionally, FIG. 5 shows example walls 510A-510C (also referred to herein individually and collectively using reference number 510) with rough or designed surfaces. Wall 510A has a generally rough surface with varying depths, while walls 510B and 510C have surfaces with depths that vary according to a sinusoidal pattern and a triangular wave pattern, respectively. The varying depths of walls 510 provide benefits in various embodiments. For example, walls 510 with varying depths may provide greater acoustic diffusion, improved thermal conductivity because of their larger surface area, or increased filtration by providing greater traction for particulates.

One or more dimensions of cells may be modified in different embodiments to modify filtering properties of cells, modify sound attenuation by cells (e.g., control wavelengths of sound attenuated by cells), provide a more secure division between regions of a product having different pressures or consistencies, or provide other implementation-specific characteristics. Cells may also be distorted along one or more axes in different implementations. For example, cells are distorted to form shells or compound curves in some embodiments. Cells may also be distorted to account for certain structural forces in various embodiments or to direct acoustic waves or liquids in various embodiments. Hence, multiple properties of cells may be modified to optimize the cells, and a structure created by arranging the cells, for different implementations. As described above, thicknesses of cell walls, rib sections, openings of cells, cell dimensions, or other characteristics may be differently modified to create different combinations of properties for different implementations.

### Applications

Various products may be formed by arranging multiple cells to form structures. In some embodiments, a structure formed by arranging multiple cells is machined to form the product after arranging multiple cells. Alternatively, the structure is formed into a shape or geometric for the product during a printing process creating the arrangement of cells. For example, if a solid material is desired on one or more exterior surfaces of a product, the solid maternal may be formed during a printing process creating the arrangement or cells or may be affixed to a structure formed from printing the arrangement of cells after the structure has been printed. As described above, a structure formed by arranging cells may have uniformly arranged cells or have variably arranged cells, so cells with different patterns are in different regions of the structure. FIG. 8 illustrates a number of example products that are formed of a solid external surface and a repeating pattern of cells printed in accordance with the embodiments described herein.

Structures formed by arrangements of cells may have a range of implementations. In various embodiments, structures created by arranging cells having different patterns are used for structural engineering. Tubes formed by arranging cells with different patterns have greater strength than extruded tubes with similar dimensions, and walls formed from arranging cells based on a pattern are stronger and lighter than solid walls. Similarly, bricks comprising arranging cells arranged basted on a pattern, while providing increased strength and thermal insulation, than solid bricks with similar dimensions. Additionally, creating various three-dimensional shapes from arrangements of cells reduces the weight of those shapes relative to casting the shapes. In other embodiments, arranging cells allows formation of structures to filter air or liquid or to provide thermal or acoustic insulation.

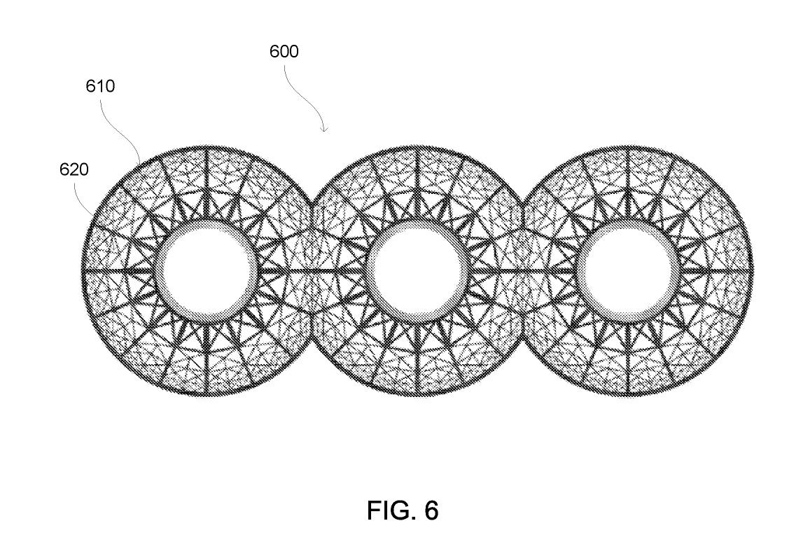

As an example, structures from arranging cells may be used in various automotive products. For example, a cylinder block 600, shown in FIG. 6, comprises an arrangement of cells having ribs configured to direct heat away from a center of a cylinder. Additionally, cells within a threshold distance of the center of the cylinder are larger to allow more coolant to flow through the cells and increase the area of the cells contacting the coolant to more quickly cool the center of the cylinder. In various embodiments, cell size decreases as distance from the center of the cylinder increase, so cells 610 farther from the center of the cylinder are smaller than cells 620 closer to the center of the cylinder.

Additionally, other automotive products that are conventionally cast or machined (e.g., crankcase housing, transmission housing) may be generated by arranging multiple cells. Framing, tubing, brackets, or other components conventionally extruded or machined may also be created by arranging various cells. Arranging cells (e.g., by printing the arrangement of cells via one or more three-dimensional printing methods) to create components having complex joints provides components that are lighter and stronger than may be lighter or stronger than casting or machining the joints. In some embodiments, an automotive frame is created by arranging multiple cells, allowing the frame to be created as a single structure by printing the various cells. Other components, such as mufflers, radiators, oil coolers, or air filters may similarly be generated by arranging various cells.

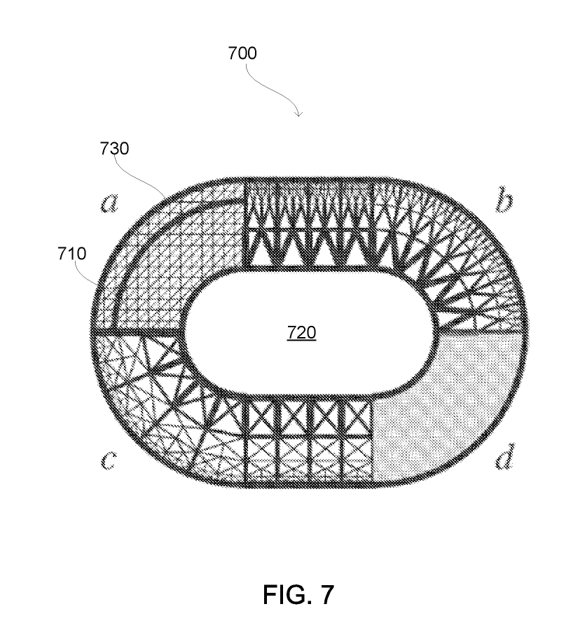

Products for other implementations may similarly be generated by arranging cells. For example, various arrangements of cells may be used for liquid cooling of various structures. FIG. 7 shows an example structure 700 for cooling. In the example of FIG. 7, a liquid filled region of cells 710 captures heat from the center 720 of the structure, while an air-filled ring of cells 730 proximate to an outer surface of the structure insulates the heat captured by the liquid filled region of cells 710. Additionally, cells may be arranged so that cells decrease in size as a distance from the center 720 of the structure increase. For example, a number of cells doubles as a distance from the center 720 of the structure increases by a threshold amount. Similarly, an area of ribs in various cells and volume of various cells may decrease as the distance from the center 720 of the structure increases.

FIG. 8 shows other example products where structures formed from arrangements of cells cool or heat air. For example, a heater 810 includes a pipe 820 at least partially included in a chamber 830 contacting an exterior surface of the pipe 820 and comprising multiple cells positioned relative to each other via a pattern. Liquid or air may be included in or may flow through the chamber 830. A fluid or a gas in the pipe 820 is heated, so the chamber 830 conducts heat from the fluid or gas in the pipe 820 to heat the liquid or air in the chamber 830.

As another example, a radiator 840 comprises various cells 845A, 845B arranged based on a pattern. As heated liquid or gas passes through the radiator 840, heat from the liquid or gas is transferred to the 845A, 845B. As air flows across the radiator, heat transferred to the cells 845A, 845B is dissipated. An alternative radiator 850 includes tubes comprising open cells and cells at least partially contacting the tubes according to a pattern. As a liquid or gas flows through the tubes, heat from the liquid or gas is transferred to the cells, cooling the liquid or gas flowing through the tubes.

Various other products may be created by arranging multiple cells. For example, hulls of aircraft or watercraft may be formed by printing arrangements of multiple cells, as well as lifeboats or diving suits. In products used as pressurized containers, constructing the products using closed cells arranged based on a pattern, the products are more likely to resist puncturing and cracking than conventionally-constructed products, increasing product safety. As another example, foam may be formed by arranging various cells, allowing more precise specification of elastic properties for various portions of the foam; in some implementations, cells of foam may be printed in a variably pressurized room to vary an elastic response of different portions of the foam.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
selecting a material;
generating a layout comprising multiple cells and identifying positions of cells relative to each other and properties of each cell; and
generating a structure comprising a plurality of cells of the selected material having positions relative to each other and properties identified by the generated layout, each cell including material occupying less than a full volume of the cell and material in the cell connecting to material in at least one additional cell in the pattern that is adjacent to the cell.

2. The method of claim 1, wherein a property of the cell comprises a thickness of one or more walls of the cell.

3. The method of claim 1, wherein a property of the cell comprises a design of a wall of the cell.

4. The method of claim 3, wherein the design of the wall of the cell is selected from a group consisting of: a wall including greater than a threshold opening, a wall including less than the threshold opening, a closed wall, and an open wall, and any combination thereof.

5. The method of claim 1, wherein the layout includes cells at different locations that have different properties.

6. The method of claim 1, wherein the layout identifies different numbers of cells at different locations in the layout.

7. The method of claim 1, wherein the material comprises metal.

8. The method of claim 1, wherein the material is selected from a group consisting of: plastic, an elastic material, and an edible material.
